(19) United States
(12) Patent Application Publication
(10) Pub. No.: US 2013/0243598 A1
(43) Pub. Date: Sep. 19, 2013

(54) BEARING AND WIND TURBINE CONTAINING THE BEARING

(71) Applicants: Sebastian Ziegler, Utrecht (NL); Bernie van Leeuwen, Utrecht (NL); Armin Olschewski, Schweinfurt (DE); Arno Stubenrauch, Aidhausen (DE); Alexander de Vries, Tiel (NL)

(72) Inventors: Sebastian Ziegler, Utrecht (NL); Bernie van Leeuwen, Utrecht (NL); Armin Olschewski, Schweinfurt (DE); Arno Stubenrauch, Aidhausen (DE); Alexander de Vries, Tiel (NL)

(73) Assignee: AKTIEBOLAGET SKF, Goteborg (SE)

(21) Appl. No.: 13/616,657

(22) Filed: Sep. 14, 2012

(30) Foreign Application Priority Data
Sep. 14, 2011 (DE) 10 2011 082 811.7

(51) Int. Cl. F03D 11/00; H02K 7/14

(52) U.S. Cl. CPC F03D 11/0008; H02K 7/14
USPC 416/147; 310/67 R

(57) ABSTRACT

A bearing adjusts an angle of attack of a rotor blade of a wind turbine according and includes first and second bearing rings that are rotatable relative to each other. The first bearing ring includes, as a slider or translator of a linear motor, a plurality of magnetic field sources disposed adjacently around at least a part of its circumference. The magnetic field sources are disposed such that each two adjacently disposed magnetic field sources generate a magnetic field with alternating polarity. The second bearing ring includes, as a stator of the linear motor, a group of at least two coils disposed adjacently around at least part of its circumference. A wind turbine includes a rotor coupled to at least one rotor blade via such a bearing, which enables the angle of attack of the rotor blade to be adjusted during operation.

### CROSS-REFERENCE

This application claims priority to German patent application no. 10 2011 082 811.7 filed on Sep. 16, 2011, the contents of which are fully incorporated herein by reference.

### TECHNICAL FIELD

The present invention generally relates a bearing comprising a linear motor and a wind turbine containing such a bearing.

### BACKGROUND

For wind turbines, the speed at which a rotor of the particular wind turbine rotates is influenced by a change of the angle of attack of one or more rotor blades of the particular rotor of the wind turbine. In this case, the angle of attack of the particular rotor blades can be set such that a stall results, whereby a force generated by oncoming air brakes the rotor and/or its rotor blades. In this case, for example the rotor can come to a stop. This process is also referred to as an active stall. Herein, a change in the angle of attack means that the rotor blades are rotated about their longitudinal axis, relative to the oncoming air, i.e. to present a smaller contact surface to the wind or gusts.

For wind turbines, it is often therefore useful to provide a suitable possibility to change the angle of attack of the rotor blades, in order to limit the power output of the particular system and to protect the system from overload. The angle, though which the rotor blades are rotated in order to control the power output of the wind turbine, typically falls in the range between a few degrees and up to 25° or more. In emergency situations, however, the rotor blades are often rotated 90°, in order to stop the rotor as described above.

A change in the angle of attack of the rotor blades can be achieved in a different way. In the case of somewhat smaller wind turbines having an output of up to 300 kW, wherein typical values fall in the area of approximately 100 kW, mechanical systems are often utilized, in which the change of the angle of attack is effected by centrifugal forces. In the case of medium-sized wind turbines, which typically have an output in the range between approximately 300 kW and 500 kW, hydraulic systems are used to adjust the angle of attack. In larger wind turbines, which typically have an output of more than 500 kW, electrical systems are used to adjust the angle of attack.

Electrical systems for tracking the angle of attack of a rotor blade often have the positive effect that the power output of the wind turbine can be controlled and monitored more accurately. In addition, the overall service life of the components of a wind turbine can often be increased, since load peaks can be prevented, if necessary. Electrical systems also have the advantage over hydraulic systems that the danger of a leak of hydraulic fluids is eliminated.

Newer wind turbines having an output power of over 500 kW are typically equipped with electrical systems for adjusting and/or tracking the angle of attack of the rotor blades, since the angle of attack of the individual rotor blades can, in the case of a wind turbine having more than one rotor blade, be individually controlled via electric motors. As a result, installation space can be saved in the interior of the rotor housing.

In this context, double-row large size angular contact ball bearings are often used as angle-of-attack or pitch bearings. In this case, one of the bearing rings has gear teeth, via which the electric drive is connectable with the bearing ring. The inner ring is often connected to the corresponding rotor blade so as to rotate therewith, so that it has corresponding gear teeth on its inner side.

A comparatively large torque is often required to adjust the angle of attack of the rotor blades. For this reason the electric drive typically has a one-step or multiple-step planetary gearing or also a worm gearing, which is disposed between the electric motor and a pinion engaged with the particular rolling-element bearing ring.

The manufacturing of a bearing ring with appropriate gear teeth, however, represents a major challenge due to the tolerances to be maintained, the material properties that are required and must be maintained in the area of the gear teeth (e.g. hardness and toughness) and other properties. The manufacturing of the appropriate gear teeth with such large bearing rings therefore includes a process that is typically expensive.

### SUMMARY

A need therefore exists in the art to provide an improved bearing capable, e.g., of adjusting the angle of attack of a rotor blade of a wind turbine. In addition or in the alternative, a need exist to provide an improved bearing that is preferably simpler to manufacture than conventional bearings used for this purpose.

It is therefore an object of the present teachings to disclose improved bearings containing linear motors as well as wind turbines containing the same.

According to one aspect of the present teachings, a bearing capable of, e.g., adjusting an angle of attack of a rotor blade of a wind turbine, comprises a first bearing ring that is rotatable relative to a second bearing ring. The first bearing ring comprises, as a slider (translator) of a linear motor, a plurality of magnetic field sources disposed adjacent to one another around at least one part of its circumference, wherein the magnetic field sources are formed such that each two adjacently disposed magnetic field sources generate a magnetic field with alternating polarity. The second bearing ring comprises, as a stator of the linear motor, a group of at least two coils disposed adjacent to each other around at least one part of its circumference.

According to another aspect of the present teachings, a wind turbine comprises a rotor and a rotor blade as well as a bearing according to any embodiment disclosed herein. The bearing is preferably disposed between the rotor and the rotor blade such that the rotor blade is mechanically connected to the first bearing ring so as to rotate therewith and the rotor is mechanically connected with the second bearing ring so as to rotate therewith, thereby making possible a change of the angle of attack of the rotor blade.

According to these aspects of the present teachings, by using a linear motor, it is no longer necessary to form gear teeth on the bearing rings, as was required in conventional bearings for wind turbines. Therefore, the linear motor can be embodied directly as part of the first and second bearing rings. That is, according to the present teachings, a conventional electric motor having a corresponding transmission is replaced by a direct drive motor. This can make possible not only a sufficiently high torque and a good controllability and monitorability, but can also make superfluous the use of a transmission and the backlash connected with it.

By omitting a transmission, gear teeth wear that typically occurs over time can also be avoided. Such gear teeth wear could occur in previously-known embodiments having a gear-based transmission, with the result that precise adjustability could no longer be ensured. In such a case, a very costly replacement was often necessary with conventional bearings, which can preferably be avoided through the use of a bearing according to the present teachings.

Likewise, by using a bearing according to the present teachings, installation space can be saved in the interior of the wind turbine, for example in the interior of the rotor housing, since the additional mechanical components, in particular a corresponding transmission, can be omitted.

A bearing according to the present teachings can be embodied as a rolling-element bearing, which has a plurality of rolling elements disposed between the first bearing ring and the second bearing ring and in contact with raceways of the first and second bearing rings. Thus the bearing can, for example, be a single row or a multiple row bearing, for example a double row four point bearing.

In other exemplary embodiments, the bearing can, however, also be a sliding bearing. Regardless of the type of bearing implemented, a bearing according to the present teachings can further include a lubrication system as an optional component.

In an exemplary embodiment of a bearing, the coils of the group of coils and the magnetic field sources of the plurality of magnetic field sources may disposed such that the coils face the magnetic field sources. This configuration makes possible an improved coupling or interaction of the magnetic field or of the magnetic flux of the magnetic field sources with the coils by reducing the distance between the coils and the magnetic field sources.

In an exemplary embodiment, adjacent coils of the group of coils can also have a matching winding orientation. In such a case, all of the coils in the group can have the same winding orientation. In other embodiments, however, an alternating winding orientation can be implemented for adjacent coils. Independent of the winding orientation, the coils can be connected in series or in parallel.

In a bearing according to the present teachings, the plurality of magnetic field sources can be disposed substantially completely around the circumference of the first bearing ring. Thus it can be possible to enable a large displacement for the bearing. Likewise it can also be possible that the bearing can rotate over any preferred angular range, including even more than 360°.

In other exemplary embodiments of a bearing, the plurality of magnetic field sources can also be disposed around the circumference of the first bearing ring, in a predetermined angular range with respect to the midpoint of the first bearing ring, to which angular range a further predetermined angular range directly connects, in which no magnetic field sources are disposed.

In such a bearing, the predetermined angular range can encompass at least 75°. Thus it can be possible to use the angle of attack of the rotor blade not only for regulating the power output, but also, in the case of an emergency situation, the angle of attack of the rotor blade can also be rotated so far that the probability of significant damage to the wind turbine due to strong winds can be reduced. In other exemplary embodiments, the bearing can be formed such that the predetermined angular range encompasses at least 90°, in order to make possible a further turning of the rotor blade, i.e. a larger change of its angle of attack, in order to further reduce the risk of damage.

In such a bearing, the predetermined angular range can encompass an angular range corresponding to the sum of at least 90°, for example 100° or 120°, and a minimum angular range in which the group of coils is disposed with respect to a midpoint of the second bearing ring. In this way, rotation of the rotor blade, and thus an adjustment of its angle of attack, to at least 90° can optionally be ensured, so that the rotor can be turned fully “out of the wind,” in order to reduce or completely prevent the above-mentioned damage due to the occurrence of gusts or high winds.

In such a bearing, the further predetermined angular range can correspond to a minimum angular range, in which the group of coils is disposed with respect to a midpoint of the second bearing ring. In other exemplary embodiments, the further predetermined angular range can also comprise a multiple of, for example two-fold or three-fold, the predetermined angular range. The use of a linear motor thus makes possible a frugal implementation of the necessary magnetic field sources in comparison with a conventional electric motor. This not only allows for a reduction in cost for the manufacture of a bearing according to the present teachings, but also allows the manufacturing to be simplified.

In a bearing according to the present teachings, the group of coils can be disposed such that a ratio of an angle, at which two adjacent coils of the group of coils are disposed with respect to a midpoint of the second bearing, to a further angle at which two adjacent magnetic field sources are disposed with respect to a midpoint of the first bearing ring, falls between 0.6 and 0.95 or between 1.05 and 1.4. This allows a compact construction of the linear motor to be implemented and/or a torque development and/or a responsiveness of the linear motor optionally to be improved. In other exemplary embodiments the above-mentioned ratio can also fall for example in the range between 0.8 and 0.95, or between 1.05 and 1.25, or also between 0.85 and 0.95 or between 1.05 and 1.15. In this case, the required installation space can optionally be used more efficiently and/or the responsiveness and/or the torque development can be further improved.

In another exemplary embodiment, the total number of coils on the second bearing ring is may be different from the number of magnetic field sources on the first bearing ring. In further exemplary embodiments, the total number of coils on the second bearing ring is thus less than a third, a fourth, a fifth, or a seventh of the total number of magnetic field sources on the first bearing ring. But here also, in other embodiments a suitable different ratio of the total number of coils and magnetic field sources can be implemented.

In a bearing according to the present teachings, the group of coils can be disposed with respect to a midpoint of the second bearing ring in an angular range of not more than 30°. Thus it can be possible to further spatially restrict the use of magnetic field sources and/or further increase the possible movement path of the linear motor. Thus a simpler and/or more cost-effective manufacture of a bearing according to the present teachings can optionally be made possible.

In such a bearing, a further angular range can connect directly to the angular range; in the further angular range, no coils are disposed on the second bearing ring, and the further angular range encompasses at least 30°. In other exemplary embodiments, the further angular range can encompass at least 45°, at least 75°, at least 90°, at least 100° or at least 120°. Thus in a further exemplary embodiment, each plurality of magnetic field sources can optionally be associated with exactly one group of coils.

In a bearing according to the present teachings, the coils of a group of coils can be disposed on a common yoke. In this way the efficiency of the linear motor and thus the achievable torque can optionally be improved.

In such a bearing, only the coils of one group of coils, i.e. the coils of exactly one single group of coils, are disposed on the common yoke. In this case, the efficiency of the linear motor can optionally be further increased, since any possible interference or overlapping with magnetic fields of other coils can preferably be avoided.

The common yoke can, for example, be manufactured from a magnetically soft material. In this case, a further increase in efficiency of the linear motor is optionally possible through a better channeling of the magnetic field lines through the yoke.

According to another aspect of the present teachings, the bearing may include a plurality of groups of coils disposed, for example at regular intervals, around the first bearing ring, wherein no coils are disposed between each two adjacent groups of coils in an angular range of at least 30° around the circumference of the second bearing ring. The first bearing ring can then comprise a further plurality of magnetic field sources that are adjacently disposed around a part of the circumference of the first bearing ring, wherein the magnetic field sources of the further plurality of magnetic field sources are formed such that each two adjacently disposed magnetic field sources generate a magnetic field with alternating polarity. By providing a second group of coils and a corresponding further plurality of magnetic field sources, i.e. a second linear motor, a further increase of the torque of the linear motor can optionally be achieved.

In such an exemplary embodiment, due to a minimum ensured displacement of the linear motor, i.e. a minimum change region of the angle of attack of the rotor blade from for example 90° or more, it can be advisable or even necessary to utilize at most three groups of coils or at most two groups of coils.

In bearings according to the present teachings, the magnetic field sources of the plurality of magnetic field sources can each comprise a permanent magnet, for example a NdFeB permanent magnet, and/or a coil. If a permanent magnet is used, a simpler manufacture of a bearing is made possible, since an electrical connection of the magnetic field sources can then be omitted. If a coil is used as the magnetic field source, a better controllability of the linear motor can optionally be achievable. A guiding or conduit for the electric cable that connects the coils is in this case often unproblematic, since the maximum rotational angle through which the bearing must be able to pivot is typically substantially less than 360°. Moreover a combination of the two options described above is also possible, wherein one or more coils are used to strengthen the magnetic field generated by one or more permanent magnets.

The magnetic field sources can optionally comprise a magnetically soft material for channeling the magnetic field lines. In this case, a more precise matching of the magnetic field sources to the geometry of the bearing can optionally occur, whereby the efficiency of the linear motor can optionally be increased.

In bearings according to the present teachings, the first bearing ring can be an inner ring of the bearing and the second bearing ring can be an outer ring of the bearing. This configuration represents the configuration that is most often used in wind turbines. Of course in other exemplary embodiments the first bearing ring can also be the outer ring of the bearing, while the second bearing ring can be the inner ring of the bearing.

Moreover the possibility exists, of course, of also using a bearing according to the present teachings such that one or both bearing rings, i.e. the first and the second bearing ring, carry out rotational or translational motion with respect to a further component. The use of the terms “stator” and “slider (translator)” in this context simply reflect the usage of common terminology in the context of linear motors, but, however—in particular with regard to the use of the term “stator”—do not indicate any fixing of a stationary arrangement of the particular bearing ring. Thus a bearing ring according to the present teachings can also optionally be used such that the second bearing ring is considered to be rotating.

A “midpoint” of a bearing ring is in this context understood to be a (any) point on an axis of the bearing, a rotational axis of the bearing, an axis of symmetry, or a rotational axis of the particular bearing ring.

An “angle” or “angular range” in the context of the above or below description is further understood to be an angle that represents a minimum angle or a minimum angular range, as long as something else is not required by the context or is explicit mentioned. Thus for example if groups or other objects encompass an angle or are disposed in an angular range, then “angle” or “angular range” is understood to be the smallest numerical value of the corresponding angle or angular range. Multiples of 360° are in general only rarely considered, such as correspondingly large angles, which optionally encompass bisecting lines, planes, or other geometric objects with one another.

Two objects are said to be “adjacent” if no additional object of the same type is disposed between them. Objects are “immediately adjacent” if they border each other, i.e. for example are in contact with each other.

A friction-fit connection results from static friction, a materially-bonded connection results from molecular or atomic interactions and forces, and an interference-fit connection results from geometric connection of the respective connecting partners. The static friction thus presupposes in particular a normal force component between the two connecting partners.

As already described above, bearings according to the present teachings can for example be used in connection with a wind turbine. They can therefore be implemented as large size bearings, large size rolling-element bearings, or large size sliding bearings. Due to their pivoting range typically being limited to less than 360°, they are also referred to as pivot bearings.

However, it should be understood that the present bearings may be advantageously utilized in any applications other than wind turbines, where a pivoting of the bearing rings relative to each other is desirable.

Further objects, embodiments, advantages and designs of the present teachings will be explained in the following, or will become apparent, with the assistance of the exemplary embodiments and the appended Figures.

### BRIEF DESCRIPTION OF THE DRAWINGS

FIG. 1 shows a schematic illustration of a linear motor.

FIG. 2 shows a cross-sectional illustration through a bearing according to the present teachings.

FIG. 3 illustrates two objects disposed adjacently at an angle.

FIG. 4 shows a schematic view of a bearing according to the present teachings.

FIG. 5 shows a schematic view of a further bearing according to the present teachings.

FIG. 6 shows a schematic view of a further bearing according to the present teachings.

### DETAILED DESCRIPTION OF THE INVENTION

In the context of the present description, summarizing reference numbers are used for objects, structures and other components when the respective components or a plurality of corresponding components are described within an exemplary embodiment or within a plurality of exemplary embodiments. Passages of the description which relate to a component are therefore transferable to other components in other exemplary embodiments, to the extent that this is not explicitly excluded or it follows from the context. If individual components are indicated, individual reference numbers are used, which are based on the corresponding summarizing reference numbers. In the following description of embodiments, therefore, identical reference numbers indicate identical or comparable components.

Components which occur multiple times in one exemplary embodiment or in different exemplary embodiments can be embodied or implemented identically or differently with respect to some of their technical parameters. It is thus possible, for example, that several components within an exemplary embodiment can be embodied identically with respect to one parameter, but differently with respect to another parameter.

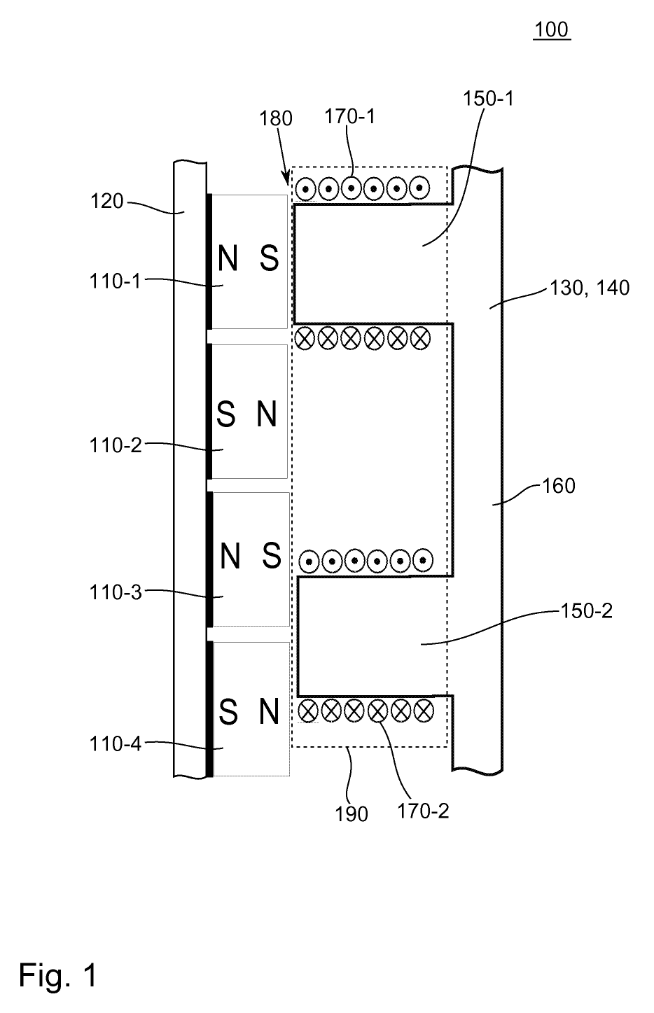

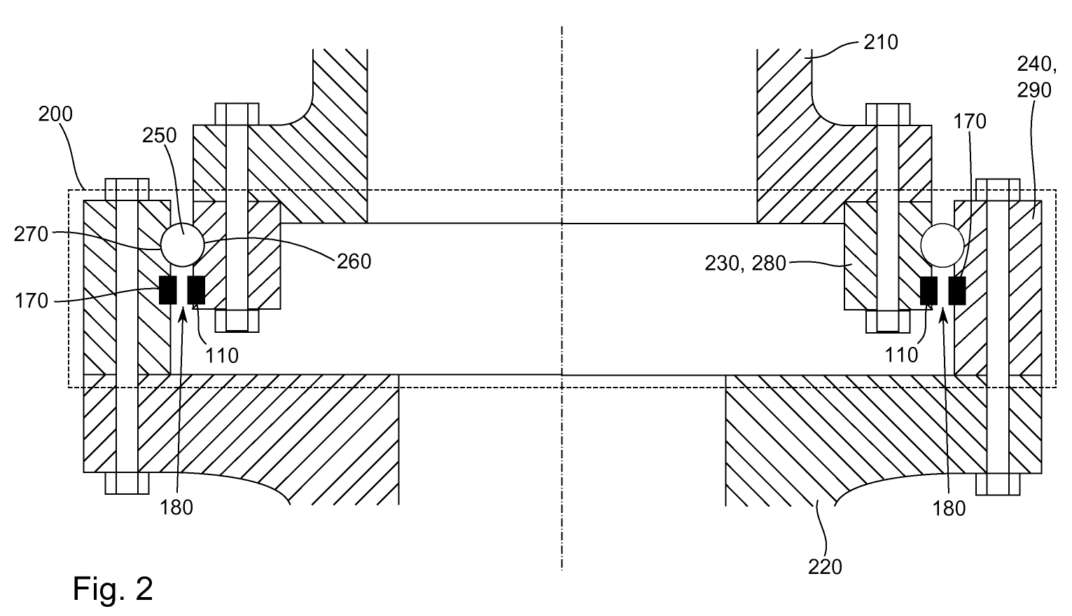

Before exemplary embodiments of a bearing and a wind turbine are described in connection with FIGS. 2 to 6, a linear motor will first be described in its basic configuration. Thus FIG. 1 schematically shows a design of a linear motor 100, as can be used for example in the context of a bearing according to the present teachings. The linear motor 100 has a plurality of magnetic field sources 110, which are adjacently disposed or formed along a component 120 in such a way that adjacent magnetic field sources 110 generate or provide an alternating polarity with respect to their magnetic field or their magnetic flux.

Thus in FIG. 1, for ease of illustration, a linear motor or a section of a linear motor 100 is shown, which comprises four magnetic field sources 110-1, . . . , 110-4. As also shown in FIG. 1 by the indicators for their polarities (“N” for north and “S” for south), each two adjacent magnetic field sources, for example the magnetic field sources 110-1 and 110-2, generate corresponding magnetic fields with different polarity. The same applies for the further magnetic field sources 110 shown in FIG. 1.

The magnetic field sources 110 are mechanically connected with the component 120. This connection can occur for example through a materially-bonded connection, a friction fit connection, or an interference fit connection, or also through a combination of two or more of these. Thus the connection can optionally occur through gluing or screws. Depending on the specific implementation, the component 120 can for example comprise a magnetically soft material or also can be manufactured from this material, in order to make possible a channeling of the magnetic field lines of the magnetic field sources 110 in its interior.

The linear motor 100 further comprises another component 130, which can for example be a yoke 140. The yoke 140 comprises at least one section 150, which rises above a base section 160 of the yoke 140. A coil 170 is disposed on the at least one section 150 and can be supplied with an electric current via an appropriate supply line not shown in FIG. 1.

Thus FIG. 1 shows a linear motor 100 or a section of the same, which comprises two sections 150-1, 150-2 and two corresponding coils 170-1, 170-2. FIG. 1 shows the windings of the coils 170 and their winding orientation, as it depicts the direction of the current flow in the windings of the coils 170 when a current is supplied thereto. Two adjacent coils, i.e. for example the coils 170-1 and 170-2, have an identical winding orientation. The coils 170 can be connected in parallel or in series.

The coils 170 and the magnetic field sources 110 are disposed such that a gap 180 is present between them, through which the magnetic field lines generated by the magnetic field sources 110 penetrate into the coil 170 or the yoke 140. Also, the yoke 140 can of course be manufactured from a magnetically soft material or at least comprise it, in order to make possible a channeling of the magnetic field lines in its interior. The width of the gap 180 determines the coupling strength, with which the magnetic field lines of the magnetic field sources 110 couple into the coils 170. Accordingly, this gap should be designed as small as possible, however large enough that, even in the event of vibrations and other mechanical influences, a collision or contact of the coils 170 with the magnetic field sources 110 is prevented.

The magnetic field sources 110 can in principle be realized based on permanent magnets or also based on coils. In the first case the magnetic field sources 110 can for example be implemented based on a neodymium iron boron magnet (NdFeB magnet). Naturally, however, other permanent magnets can also be used. Moreover, of course, the magnetic field sources 110 can likewise be realized based on coils. While with the use of permanent magnets they are mechanically connected with the component 120 and appropriately oriented for the generation of the alternating polarity, in the case of an implementation based on coils, the alternating polarity of adjacent magnetic field sources 110 can be realized by wiring and/or an alternating winding orientation. Of course, combinations of a permanent magnet and a coil can also be implemented in the context of the magnetic field sources 110. Thus the magnetic field of the permanent magnet can optionally be increased through the use of an additional coil.

Independently from this, the magnetic field sources 110 and/or component 120 can comprise a magnetically soft material for channeling the field lines of the magnetic field sources 110. In this way a better matching of the magnetic field sources 110 to the geometry of the linear motor 100 is optionally achievable.

A linear motor 100 represents an electric drive motor, which in contrast to common rotating motors does not displace an object connected to it in a rotating movement but rather in a substantially rectilinear movement (translational movement). At the same time, in principle either an asynchronous—the magnetic field is not fixedly coupled with the movement—or a synchronous mode of operation—for example with a linear stepper motor—is possible.

A linear motor 100 follows the same functional principles as a rotary current motor, wherein the original, circularly-disposed electrical excitation windings (stator) are instead disposed on a flat track. The “runner” or translator (slider), which corresponds to the rotor of the rotary current motor, is pulled, in the case of the linear motor, along the movement path by the axially moving magnetic field. Hence the widely-used term “Wanderfeldmachine” (moving field motor). A linear motor 100 can thus be seen as an “unrolled” version of a rotating electric motor. It produces a linear force along its extension or length.

A linear motor is not limited to straight paths in the sense of a mathematical line or line segment. Linear motors 100 can rather also be used for movement along a curved path or line and accordingly can be formed in curved shape.

Linear motors 100 can make it possible to directly execute a translational movement. They thus make possible the construction of direct drives, in which a gear reduction or transmission can be omitted. In this field, linear motors have the advantage of high accelerations and correspondingly high forces and torques. High velocities can also optionally be achieved or generated.

Linear motors 100 can be implemented both based on conventional conductors as well as based on superconductors. In the latter case, the provision of an appropriate cooling can be advisable, in order to achieve the superconducting state of the affected components.

In the linear motor 100 shown in FIG. 1, the coils 170 are disposed in the form of a group 190, wherein each group 190 comprises at least two coils 170.

FIG. 2 shows a cross-sectional representation through a wind turbine according to the present teachings having a bearing 200 according to the present teachings. A wind turbine according to the present teachings comprises a rotor 210 as well as at least one rotor blade 220, whose respective attachment structures are shown in FIG. 2, by which they are connected with the bearing 200 to adjust an angle of attack of the rotor blade 220.

The rotor 210 in this context represents the “stationary component,” and the rotor blade 220 represents the “movable component,” since the rotor blade 220 is designed to be adjustable with respect to its angle of attack relative to the rotor 210 by using the bearing 200.

According to an exemplary embodiment, the bearing 200 is formed as a rolling-element bearing, more specifically as a ball bearing. It thus comprises a first bearing ring 230 and a second bearing ring 240, between which are disposed a plurality of rolling elements 250. The rolling elements 250 roll on raceways 260, 270 of the two bearing rings 230, 240.

The first bearing ring 230, which is formed as inner ring 280 in the present exemplary embodiment, is screwed onto the rotor 210 via corresponding bores and thus is connected so as to rotate therewith. The second bearing ring 240, which is embodied as outer ring 290 in the exemplary embodiment shown in FIG. 2, also has corresponding bores, in order to be screwable onto the rotor blade 220, in order to create a connection with the rotor blade 220 that ensures that the rotor blade 220 will rotate with the second bearing ring 240. Both the rotor 210 and the rotor blade 220 can of course be embodied in a multiple-piece manner, so that for example only corresponding attachment structures for the connection with the bearing 200 according to the present teachings are represented in FIG. 2. Naturally, in other exemplary embodiments the rotor 210 and the rotor blade 220 can also be connected, using other connecting techniques, with the corresponding bearing rings 230, 240 of the bearing 200.

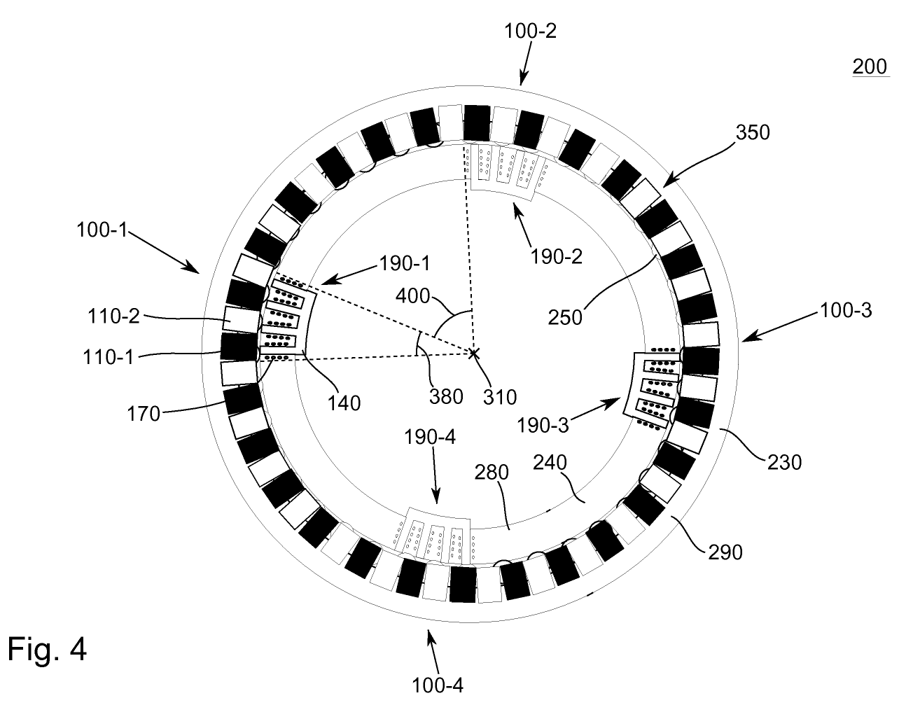

The first bearing ring 230 is formed as a slider (translator) of a linear motor and thus comprises a plurality of magnetic field sources 110 adjacently disposed around at least one part of its circumference. The magnetic field sources 110 are formed such that each two adjacently disposed magnetic field sources 110 generate a magnetic field or a magnetic flux with alternating polarity. As will be explained in more detail below in the context of FIGS. 4, 5 and 6, the plurality of magnetic field sources 110 can be substantially completely disposed around the circumference of the first bearing ring 230, or in a predetermined angular range relative to a midpoint of the first bearing ring 230 around its circumference, to which a further predetermined angular range directly connects, in which no magnetic field sources are disposed.

The second bearing ring 240 is formed as stator of a linear motor and accordingly comprises a group 190 (not shown in FIG. 2) of at least two coils 170 disposed adjacently around at least one part of its circumference. Between the magnetic field sources 110 and the coils 170, corresponding gaps 180 are formed, via which the magnetic fields of the magnetic field sources 110 and the coils 170 interact with each other.

In the exemplary embodiment of a bearing 200 shown in FIG. 2, the magnetic field sources 110 are thus disposed on the inner ring 280, and the coils 170 are thus disposed on the outer ring 290, and they thus form a direct drive for the rotor blade 220, while circumventing and avoiding a transmission. Of course, in other exemplary embodiments, the roles of the first bearing ring 230 and the second bearing ring 240 can be interchanged with respect to their characterization as the inner ring and outer ring. In such a case the inner ring 280 would be facing the second bearing ring 240 and the rotor blade 220, while the outer ring 290 would be facing the first bearing ring 230 and the rotor 210.

Although in FIG. 2 the bearing 200 is shown as a single-row ball bearing according to the present teachings, exemplary embodiments are in no way limited to this type of bearing. Thus corresponding bearings 200 can for example be formed as double or multiple row bearings. Other rolling elements 250 than balls can also be used. Thus, for example, barrel, cylindrical, needle-shaped, or conical rolling elements could be used as rolling elements 250. Exemplary embodiments can also be implemented based on angular contact ball bearings, for example four point ball bearings. But bearing 200 can also be implemented according to the present teachings as a sliding bearing.

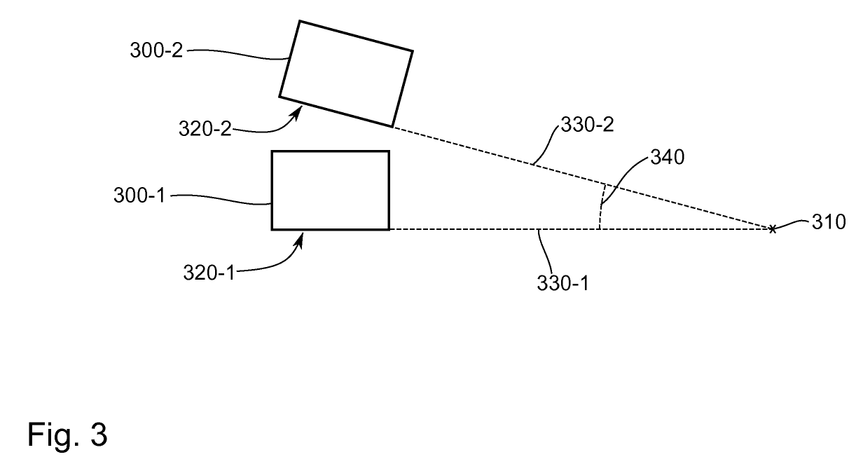

Before a view of a bearing according to the present teachings is explained in more detail and described in connection with FIG. 4, first it will be explained in connection with FIG. 3 what is meant by an “angle,” by means of which two objects are adjacently disposed with respect to a midpoint.

Thus FIG. 3 shows a first object 300-1 and a second object 300-2, which are adjacently disposed with respect to one another. As was explained previously, this means that a further identical or similar object 300 is disposed between these two objects 300-1, 300-2. The objects 300 are further oriented to a midpoint 310, which is marked in the figure with an “X.” Accordingly, the objects 300 each have a chosen direction 320-1 and 320-2, which is for example an outer edge, a magnetization, or another characteristic orientation of the particular object 300.

The orientation of the objects 300 towards the midpoint 310 in this case means that their chosen directions 320 are oriented towards the common midpoint 310. Accordingly, connecting lines 330-1 and 330-2, which connect the midpoint 310 with each object 300, run parallel to the chosen directions 320 of each object 300.

In the case shown in FIG. 3, it is a fact that the objects 300 each have just one corresponding chosen direction 320, which converge towards the common midpoint 310. In other cases, in which the corresponding chosen directions 320 can be assigned to the objects 300, but they are not oriented towards the midpoint 310, the connecting lines 330, which connect the midpoint 310 and the corresponding object 300, with the preferred direction 320 of the corresponding object encompass an angle that is the same for all involved objects 300. The first mentioned case thus represents a special case of the more general, second case, wherein the corresponding angle is 0°.

The objects 300 can for example be coils 170 or magnetic field sources 110. Depending on how the corresponding objects 300 are implemented, corresponding chosen directions 320 can for example be given by their geometric design, i.e. for example by their external shape, or however also by functional features. Thus for example in the case of a magnetic field source 110, a magnetization or a bare magnetic field generated by the magnetic field source can represent the chosen direction 320. In this context, angles caused by alternating polarity (angles of approximately 180°) optionally remain unconsidered. Likewise, in the case of a coil 170, a magnetic field generated or generatable therewith can be used as the chosen direction 320. Depending on the specific implementation, angles due to wiring and/or a winding orientation (angles of approximately 180°) remain unconsidered. Alternatively or additionally, likewise a geometric design of the coil 170, for example a surface normal, which is given by the coil windings, can be used.

The aforementioned angle is the angle 340, which the connecting lines 330 enclose with each other. As has been mentioned previously, in this context a midpoint 310 is understood to be a—any, for example disposed in a plane perpendicular to the corresponding structures—point on an axis or axis of rotation of a bearing at 100 according to the present teachings or on a symmetrical or axis of rotation of a bearing ring 230, 240.

FIG. 4 shows a view of a bearing 200 according to the present teachings with a first bearing ring 230, wherein it is—different from the bearing 200 shown in FIG. 2—an outer ring 290. Accordingly a second bearing ring 240 is formed as the inner ring 280 of the bearing 200. A plurality 350 of magnetic field sources 110 is mechanically connected with the first bearing ring 230. In this exemplary embodiment of a bearing 200, the magnetic field sources 110 are substantially disposed completely around the circumference of the first bearing ring 230. Two magnetic field sources 110 disposed adjacently to each other respectively generate a magnetic field with alternating polarity. In FIG. 4 this is shown by illustration of the magnetic field sources 110 in black and white. The two magnetic field sources 110-1 and 110-2, marked with a reference number in FIG. 4, are thus correspondingly disposed as has previously been described in connection with FIG. 1.

The bearing 200 further includes at least one group 190 of coils 170, of which only one is provided with a reference number in FIG. 4 in order to simplify the illustration. More specifically, the bearing 200 in FIG. 4 includes in total four groups 190-1, . . . , 190-4 of coils 170. The coils 170 of a group 190 of coils 170 are each disposed on a common yoke 140, on which only the coils 170 of the particular group 190 are disposed. The groups 190 of coils 170 as well as the plurality 350 of magnetic field sources 110 thus form a linear motor 100-1, . . . , 100-4, as was described in connection with FIG. 1.

The four groups 190 of coils 170 are identically formed in this exemplary embodiment of a bearing 200, but are disposed at approximately 90° with respect to one another around a common midpoint 310 of the first and of the second bearing ring 230, 240. They each extend over an angular range 380 of about 22°, which is only drawn in connection with the group 190-1 in order to simply the illustration of FIG. 4. Of course, in other exemplary embodiments, the groups 190 of coils 170 can also extend over an angular range 380 that deviates from approximately 22°. The groups 190 can also optionally be embodied differently. Each angular range 380 of the individual groups 190 can thus be larger or smaller.

The angular range 380 is typically defined as the smallest angular range in which each group 190 of coils 170 can be completely encompassed. Of course in other exemplary embodiments a smaller or larger number of groups 190 of coils 170 can also be implemented. Thus for example only a single group 190 of coils may be encompassed. Likewise, however, two, three, or more than four groups 190 can be provided.

In a bearing 200 according to the present teachings, the individual groups 190 of coils 170—independent of their number—are typically disposed in a minimum angular range 380 of at most 30° with respect to a midpoint 310. Here the design of the drive of the linear motor 100 now comes into consideration. In other exemplary embodiments the angular range 380 can also be reduced to at most 25°, at most 20° or at most 15°.

Thus, in many exemplary embodiments of a bearing 200, a further angular range 400 of the second bearing ring 240, in which no coils are disposed and is therefore free from coils, is directly connected to the angular range 380 of the second bearing ring 240, in which a group 190 of coils 170 is completely disposed. This further angular range 400 of the second bearing ring 240 often extends at least over 30°, at least over 45°, at least over 75°, at least 90°, at least 100°, or at least 120°.

As has already been described above in connection with FIGS. 1 and 2, the magnetic field sources 110 can each comprise a permanent magnet, for example a NdFeB magnet, or also a coil. Of course magnetic field sources 110 can likewise embody a combination of both techniques, wherein for example a magnetic field generated by a permanent magnet is amplified with the help of a coil.

On the one hand, to make possible a good responsiveness of the linear motor 100 with its magnetic field sources 110 and its coils 170 and on the other hand also a good torque development or force development, the groups 190 of coils 170 can be disposed in such a way that a ratio of an angle, at which two adjacent coils 170 of a group 190 of coils 170 are disposed relative to the midpoint 310, to a further angle, at which to adjacent magnetic field sources 110 (for example the magnetic field sources 110-1 and 110-2) are disposed relative to the midpoint 310, falls between 0.6 and 0.95 or between 1.05 and 1.4. In other exemplary embodiments, the ratio can likewise fall between 0.8 and 0.95 or between 1.05 and 1.25, or also between 0.85 and 0.95 or between 1.05 and 1.15. Of course other ratios can also be implemented in exemplary embodiments. This can for example be of interest when the linear motor 100 is embodied as a stepper motor.

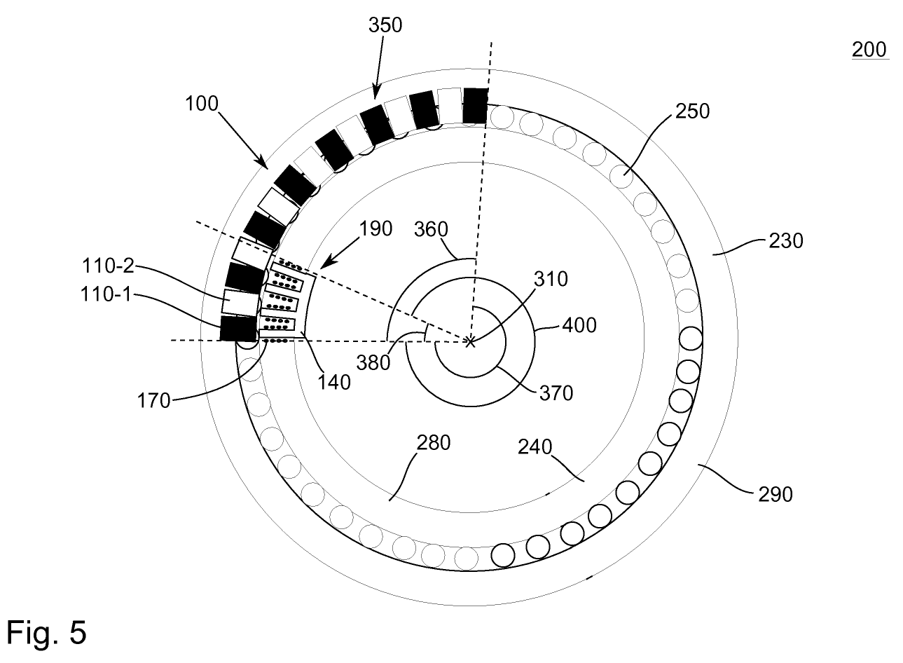

FIG. 5 shows a view of a further bearing 200 according to the present teachings. The bearing 200 from FIG. 5 differs from the bearing 200 shown in FIG. 4 with respect to several points. Thus the magnetic field sources 110 are also adjacently disposed here around at least one part of the circumference of the first bearing ring 230, wherein two adjacently disposed magnetic field sources 110 accordingly also generate a magnetic field with alternating polarity. This is also represented again by illustration of the magnetic field sources 110 in black and white. The two magnetic field sources 110-1 and 110-2, provided with a reference number in FIG. 5, are thus disposed as was already described previously in connection with FIG. 1.

However, in this case, the plurality 350 of magnetic field sources 110 is only disposed in a predetermined angular range 360, to which a further predetermined angular range 370 connects, in which no magnetic field sources 110 are disposed. In other words the further predetermined angular range 370 is free of magnetic field sources. In the exemplary embodiment of a bearing 200 shown in FIG. 5, the predetermined angular range 360 extends over approximately 90°. Since the bearing 200 in FIG. 5 has a plurality of magnetic field sources 110, the further predetermined angular range 370 correspondingly extends over approximately 270°. In other exemplary embodiments of a bearing 200, the predetermined angular range can also be formed smaller or larger. In many exemplary embodiments however, it is useful to implement a predetermined angular range that encompasses at least 75°.

The bearing 200 further has only one group 190 of coils 170, of which for simplicity of illustration in FIG. 5 only one is provided with a reference number. The coils 170 of the group 190 of coils 170 are disposed on a common yoke 140, on which only the coils 170 of the group 190 are disposed. The group 190 of coils 170 and the plurality 350 of magnetic field sources 110 form a linear motor 100, as has been described in connection with FIG. 1.

In this case, the group 190 of coils 170 extends over an angular range 380 of approximately 22°. Of course in other exemplary embodiments the group 190 of coils 170 can also extend over an angular range 380 that deviates from approximately 22°. This can be larger or also smaller. To make possible an overlap in the angular range between the magnetic field sources 110 and the coils 170, the bearing illustrated in FIG. 5 thus has an effective displacement of approximately 68° (=90°−22°). In other words the effective displacement results from the difference of the predetermined angular range 360 and the angular range 380, over which the coils 170 of the group 190 of coils 170 extend.

To make possible, for example, a displacement of 90°, it can be advisable to dispose the magnetic field sources 110 over a predetermined angular range 360, which corresponds to the sum of 90° and a minimum angular range 380, in which the group 190 of coils 170 is disposed relative to a midpoint 310 of the second bearing ring 240. The midpoint 310 of the second bearing ring 240 coincides here with the midpoint of the first bearing ring 230. In other words, it can be advisable to dispose the plurality 350 of magnetic fields 110 over a predetermined angular range 360, which comprises at least the sum of the intended displacement (in degrees) and the angular range 380, over which the group 190 of coils 170 extends.

In order to be able to optionally reduce the number of the magnetic field sources 110, it can therefore be useful to restrict the angular range 380 to at most 30°, at most 25°, at most 20° or at most 15°. Thus in an exemplary embodiment of a bearing 200, the group 190 of coils 170 extends over an angular range 380 between 10° and 15°.

In the exemplary embodiment of a bearing 200 shown in FIG. 5, the further predetermined angular range 370, in which no magnetic fields sources are disposed, encompasses more than twelve-fold the angular range 380, in which the group 190 of coils 170 is encompassed. In other exemplary embodiments, another multiple can be implemented, for example a one-fold, a two-fold, or a three-fold. Of course this ratio is not restricted to integer ratios. By reducing this ratio, a further linear motor 100 can optionally be implemented.

In this case, the angular range 380 is typically defined as the smallest angular range, in which the group 190 of coils 170 can be completely encompassed. With regard to the design of the magnetic field sources 110 as well as the design of the angle, at which two adjacent magnetic field sources 110 and/or two adjacent coils 170 of a group 190 are disposed, reference is made to the embodiments above. The further angular range 400, in which no coils are disposed on the second bearing ring 240 and is therefore free of coils, thus extends in this exemplary embodiment of a bearing 200 over more than 330°.

FIG. 5 thus shows a bearing 200 according to the present teachings, wherein the magnetic field sources 110 are attached to the outer ring 290, in order to channel the magnetic flux. Accordingly, coils 170 are attached to the inner ring 280. By applying current to the coils 170, a turning or rotation of the bearing 200 is thus effected. The magnetic field sources 110 can be formed here from permanent magnets and/or electromagnets, i.e. coils, or can comprise such permanent magnets and/or electromagnets.

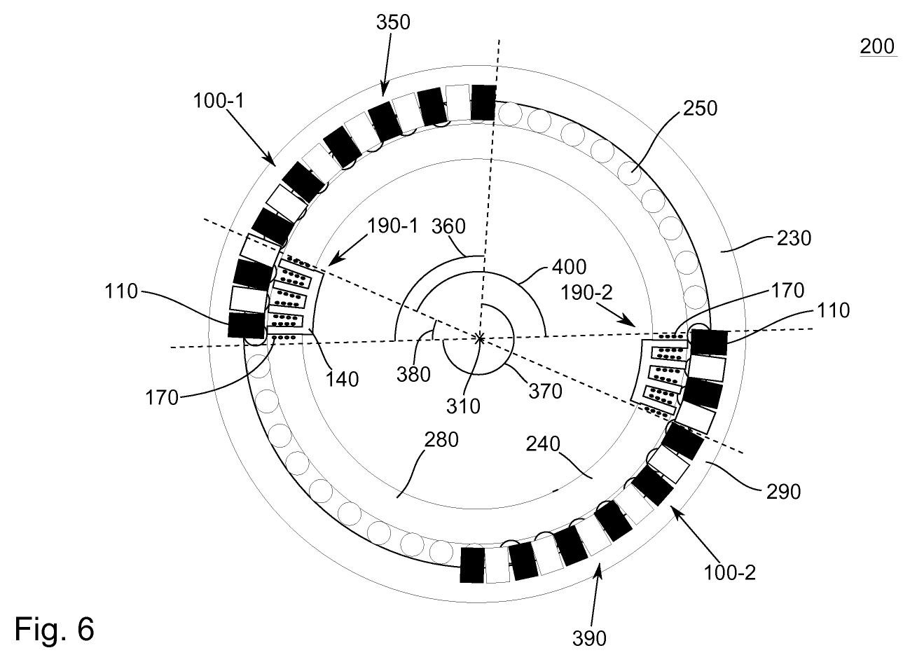

FIG. 6 shows a further exemplary embodiment of a bearing 200, which differs in essence from the bearing 200 shown in FIG. 5 in that this exemplary embodiment now comprises two linear motors 100-1 and 100-2. In the exemplary embodiment shown in FIG. 6, the two linear motors 100-1, 100-2 are identically embodied, however are disposed at an angle of 180° to each other relative to the midpoint 310.

Thus the first linear motor 100-1 includes a first group 190-1 of coils 170, which—analogous to the exemplary embodiment shown in FIG. 5—are fastened to the inner ring 280. Accordingly, the plurality 350 of magnetic field sources 110 is in turn connected with the outer ring 290.

However, the bearing 200 shown in FIG. 6 further includes a second linear motor 100-2. Due to its identical design, it also has a group 190-2 of coils 170, which are also connected with the inner ring 280, i.e. with the second bearing ring 240. Moreover, the second linear motor 100-2 includes, however, a further plurality 390 of magnetic field sources 110. The further plurality 390 of magnetic field sources 110 corresponds here, with regard to design and orientation, to the plurality 350 of magnetic field sources 110 of the linear motor 100-1.

In other exemplary embodiments of a bearing 200, the further plurality 390 of magnetic field sources 110 can, however, also be implemented differently. Independent thereof, it includes, however, magnetic field sources 110 adjacently disposed around a part of the circumference of the first bearing ring 230, wherein the magnetic field sources 110 of the further plurality 390 of magnetic field sources are likewise designed such that each two adjacently disposed magnetic field sources 110 generate a magnetic field with alternating polarity.

The two groups 190-1 and 190-2 of coils 170 are disposed here spaced from each other. More specifically, the second bearing ring 240 thus has a further angular range 400, which typically encompasses at least 30°, in which no coils 170 are connected with the second bearing ring 240.

In other exemplary embodiments, however, more than the previously mentioned number of linear motors 100 can be implemented, with a correspondingly larger number of groups 190 of coils 170 and a correspondingly larger number of pluralities 350, 390 of magnetic field sources 110. Depending on the specific implementation, in the case of an intended displacement of at least 90°, the number of linear motors 100 implemented is limited, however, to a maximum of three. In this case the groups 190 of coils 170 and/or the pluralities 350, 390 of magnetic field sources 110 are each implemented, for example, at an angle of 120° to each other with respect to a midpoint 310.

In other words, in this exemplary embodiment, the linear motors 100, which are also referred to as linear drives, are now attached on both sides of the bearing 200. In this way an increase in torque and/or force can be generated. This can for example be advisable, if due to structural requirements a single linear motor 100 can no longer suffice to provide an appropriate torque.

Exemplary embodiments of a bearing 200 thus make possible an angle-of-attack bearing for a rotor blade of a wind turbine having a direct drive based on a linear motor concept.

Exemplary embodiments of a bearing 200 can thus make possible a simpler manufacture of a bearing and/or space-saving bearing assembly and/or—due to the omitted transmission—a low-backlash angle-of-attack adjustment of a rotor blade of a wind turbine. Exemplary embodiments of a bearing can thus be used in connection with wind turbines which comprise one or more rotor blades 220. A bearing 200 according to the present teachings can, however, also be used in other systems and machines, wherein a similar adjustment of an angle of attack or a similar angle is advisable.

The features disclosed in the above description, the claims and the drawings can be used, individually or in any combination, for the realization of exemplary embodiments in their various designs and—except where the description indicates otherwise—combined with each other in any way.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearings and wind turbines and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

100 Linear Motor
110 Magnetic field source
120 Component
130 Further component
140 Yoke
150 Section
160 Base section
170 Coil
180 Gap
190 Group
200 Bearing
210 Rotor
220 Rotor blade
230 First bearing ring
240 Second bearing ring
250 Rolling elements
260 Raceway
270 Raceway
280 Inner ring
290 Outer ring
300 Object
310 Midpoint
320 Preferred direction
330 Connecting line
340 Angle
350 Plurality of magnetic field sources
360 Predetermined angular range
370 Further predetermined angular range
380 Angular range
390 Further plurality of magnetic field sources
400 Further angular range

1. A bearing comprising:
a first bearing ring,
a plurality of magnetic field sources disposed adjacently around at least one portion of a circumference of the first bearing ring and configured to act as a slider of a linear motor, the magnetic field sources being configured and disposed such that each two adjacently disposed magnetic field sources generate a magnetic field with alternating polarity;
a second bearing ring that is configured to be rotatable relative to the first bearing ring; and
a group of at least two coils disposed adjacently around at least one portion of a circumference of the second bearing ring and configured to act as a stator of the linear motor.

2. The bearing according to claim 1, wherein the plurality of magnetic field sources is disposed at least substantially completely around the circumference of the first bearing ring.

3. The bearing according to claim 1, wherein the group of coils is disposed such that a ratio of a first angle, at which two adjacent coils of the group of coils are disposed with respect to a midpoint of the second bearing ring, to a second angle, at which two adjacent magnetic field sources are disposed with respect to a midpoint of the first bearing ring, is between 0.6 and 0.95 or between 1.05 and 1.4.

4. The bearing according to claim 3, wherein the ratio is between 0.8 and 0.95 or between 1.05 and 1.25.

5. The bearing according to claim 3, wherein the ratio is between 0.85 and 0.95 or between 1.05 and 1.15.

6. The bearing according to claim 1, wherein the group of coils is disposed in a first angular range of at most 30° with respect to a midpoint of the second bearing ring.

7. The bearing according to claim 6, wherein a second angular range connects directly to the first angular range and contains no coils disposed on the second bearing ring, the second angular range encompassing at least 30°.

8. The bearing according to claim 1, wherein the group of coils is disposed on a common yoke.

9. The bearing according to claim 1, further comprising a second group of coils disposed around the first bearing ring, wherein no coils are disposed around the circumference of the second bearing ring between two adjacent groups of coils in a further angular range of at least 30°.

10. The bearing according to claim 9, wherein the second group of coils are disposed at regular intervals around the first bearing ring.

11. The bearing according to claim 1, wherein the magnetic field sources each comprise a permanent magnet and/or an electromagnetic coil.

12. The bearing according to claim 1, wherein the magnetic field sources each comprise a NdFeB permanent magnet.

13. The bearing according to claim 1, wherein the first bearing ring is an inner ring of the bearing and the second bearing ring is an outer ring of the bearing.

14. The bearing according to claim 13, wherein the group of coils is disposed such that a ratio of a first angle, at which two adjacent coils of the group of coils are disposed with respect to a midpoint of the second bearing ring, to a second angle, at which two adjacent magnetic field sources are disposed with respect to a midpoint of the first bearing ring, is between 0.6 and 0.95 or between 1.05 and 1.4.

15. The bearing according to claim 14, wherein the ratio is between 0.85 and 0.95 or between 1.05 and 1.15.

16. The bearing according to claim 15, wherein the group of coils is disposed in a first angular range of at most 30° with respect to the midpoint of the second bearing ring; and
a second angular range connects directly to the first angular range and contains no coils disposed on the second bearing ring, the second angular range encompassing at least 30°.

17. The bearing according to claim 16, wherein the group of coils is disposed on a common yoke; and
the magnetic field sources each comprise a NdFeB permanent magnet and/or an electromagnetic coil.

18. The bearing according to claim 17, further comprising a second group of coils disposed at regular intervals around the first bearing ring, wherein no coils are disposed around the circumference of the second bearing ring between two adjacent groups of coils in a third angular range of at least 30°.

19. A wind turbine comprising:
a rotor,
a rotor blade, and
the bearing according to claim 18 disposed between the rotor and the rotor blade such that the rotor blade is mechanically affixed to the first bearing ring so as to rotate therewith and the rotor is mechanically affixed with the second bearing ring so as to rotate therewith, the bearing being configured to facilitate a change in an angle of attack of the rotor blade.

20. A wind turbine comprising:
a rotor,
a rotor blade, and
the bearing according to claim 1 disposed between the rotor and the rotor blade such that the rotor blade is mechanically affixed to the first bearing ring so as to rotate therewith and the rotor is mechanically affixed with the second bearing ring so as to rotate therewith, the bearing being configured to facilitate a change in an angle of attack of the rotor blade.
